(19) United States
(12) Patent Application Publication
(10) Pub. No.: US 2025/0337663 A1
(43) Pub. Date: Oct. 30, 2025

(54) APPARATUS AND METHOD FOR MONITORING ILLEGAL DISTRIBUTION OF COPYRIGHTED WORKS THROUGH TORRENT NETWORK

(71) Applicant: WISECNS CO., LTD., Seongnam-si (KR)

(72) Inventor: Bonghan SHIN, Busan (KR)

(73) Assignee: WISECNS CO., LTD., Seongnam-si (KR)

(21) Appl. No.: 18/780,718

(22) Filed: Jul. 23, 2024

(30) Foreign Application Priority Data
Apr. 26, 2024 (KR) 10-2024-0056113

(51) Int. Cl. H04L 43/02; G06F 21/10; H04L 67/104

(52) U.S. Cl. CPC H04L 43/02; G06F 21/10; H04L 67/104

(57) ABSTRACT

Disclosed is a method for monitoring illegal distribution of copyrighted works through a torrent network, including: checking, by a processor, information on a peer distributing a torrent file designated as copyrighted works to be monitored and whether a current status of the peer is a Seeder or a Leecher, and when the peer is checked to be the Seeder, obtaining, by the processor, a captured image of a monitoring screen of the peer distributing the torrent file as evidence to prove a period of illegal distribution of the copyrighted work.

### CROSS-REFERENCE TO RELATED APPLICATION

This application claims priority to and the benefit of Korean Patent Application No. 10-2024-0056113, filed on Apr. 26, 2024, the disclosure of which is incorporated herein by reference in its entirety.

### BACKGROUND

### 1. Field of the Invention

The present invention relates to an apparatus and method for monitoring illegal distribution of copyrighted works through a torrent network, which monitors illegal distribution of the copyrighted works while not being directly involved in uploading and downloading on the torrent network and acquires evidence to specify the period of illegal distribution of copyrighted works through the torrent network.

### 2. Discussion of Related Art

In general, a torrent refers to a protocol or program that divides a file existing on the Internet into multiple pieces and allows users to share these pieces directly with one another. Various clients, such as Torrent, have been developed and are widely used.

Unlike traditional Peer-to-Peer (P2P) services, the torrent is characterized by a ‘one-to-many’ sharing method in which information of files divided into pieces is received from multiple users rather than receiving the entire data or program from another user. The more users there are, the faster the upload and download speeds are.

At this time, the roles of the sender and receiver of data switch in real-time. When a user is sharing a file, the user's server acts as a server as a sender (uploader), and when the user downloads a file from another user, he/she acts as a client as a receiver (downloader).

Once the file is shared to some extent, the user uploads and downloads file pieces as the user's terminal simultaneously performs the roles of both the server and the client. In other words, a user who has completely replicated the entire file and is only distributing the entire file acts as a Seeder. Meanwhile, in a state in which only some pieces of the file are downloaded and the file is incompletely copied, the user who is downloading and distributing the file plays the role of a Leecher (non-Seeder).

Torrent-related technology is a technology that can compensate for slow Internet speeds, but on the other hand, it serves as a channel for illegally distributing copyrighted works (i.e., copyrighted content). As a result, the illegal distribution of copyrighted content through torrent networks has caused severe damage, and millions of online pirated copies have been accumulated over the years.

Accordingly, in order to eradicate the illegal distribution of copyrighted works through the torrent network, there is a need for technology that can monitor illegal distribution of copyrighted works while not being directly involved in uploading and downloading on the torrent network (in other words, monitor the illegal distribution of copyrighted works in an integrity state without illegality), and acquire evidence to specify the period of illegal distribution of copyrighted works through the torrent network (in other words, acquire evidence that can prove the duration of copyright infringement due to the illegal distribution of copyrighted works).

The background technology of the present invention is disclosed in Republic of Korea Patent Publication No. 10-2024-0008479 (Jan. 19, 2024).

### SUMMARY OF THE INVENTION

The present invention is directed to providing an apparatus and method for monitoring illegal distribution of copyrighted works through a torrent network, which monitors illegal distribution of copyrighted works while not being directly involved in uploading and downloading on the torrent network and acquires evidence to specify the period of illegal distribution of copyrighted works through the torrent network.

According to an aspect of the present invention, there is provided a method for monitoring illegal distribution of copyrighted works through a torrent network, which includes checking, by a processor, information on a peer distributing a torrent file designated as copyrighted works to be monitored and whether a current status of the peer is a Seeder or a Leecher, and when the peer is checked to be the Seeder, obtaining, by the processor, a captured image of a monitoring screen of the peer distributing the torrent file as evidence to prove a period of illegal distribution of the copyrighted work.

In the present invention, after the obtaining of the captured image of the monitoring screen of the peer distributing the torrent file, the processor may store the information on the peer distributing the torrent file and the captured image of the monitoring screen in a DB server and a capture server, and manage the information stored in the DB and the capture server through a web server, whereby, when the managed information is submitted as the evidence of illegal distribution of the copyrighted work, the processor may be implemented to search for only illegal distribution information of a desired torrent file through the web server and output the searched information as a report.

In the present invention, when the report submitted as the evidence of illegal distribution of the copyrighted work is output, the web server may specify a period from a time point when a peer to be monitored is first discovered as a Leecher with some file pieces or as a Seeder with all file pieces to a time point when the peer is last detected as the Seeder after being switched to the Seeder, as the period of illegal distribution of the copyrighted work through the torrent network, and may allow the specified period to be included in the report when the report is output.

In the present invention, in order to check the peer distributing the torrent file designated as the copyrighted work to be monitored, the processor may load the torrent file to analyze infohash information, and check whether the corresponding torrent file has the same infohash as infohash of the torrent file of the copyrighted work to be monitored.

In the present invention, the monitoring screen may include a plurality of areas displaying at least one of information on the number of torrent files to be monitored, torrent file information, connection log information, settings information, standard time information, tracker information, and connection details information.

In the present invention, after the checking whether the current status of the peer is the Seeder or the Leecher, the method may further include terminating, by the processor, a connection with the peer distributing the torrent file to prevent from downloading the torrent file, wherein, in order to monitor the peer distributing the torrent file, the checking whether the current status of the peer is the Seeder or the Leecher, and the terminating of the connection with the peer distributing the torrent file may be repeatedly performed at a designated time interval.

In the present invention, in order to acquire the evidence that can prove the period of illegal distribution of the copyrighted work, the processor may repeatedly monitor the peer distributing the torrent file with the same infohash as infohash of the torrent file of the copyrighted work to be monitored at a designated time interval, capture the monitoring screen (First Seen) when the peer is first discovered, capture the monitoring screen (Seed Time) when the peer is determined to be the Seeder, and capture the monitoring screen (Last Seen) when the peer is last discovered.

According to another aspect of the present invention, there is provided an apparatus for monitoring illegal distribution of copyrighted works through a torrent network, which includes a processor configured to check information on a peer distributing a torrent file designated as copyrighted works to be monitored and whether a current status of the peer is a Seeder or a Leecher, and acquire, when peer is checked to be the Seeder, a captured image of a monitoring screen of the peer distributing the torrent file as evidence to prove a period of illegal distribution of the copyrighted work, and a monitoring screen display configured to display at least one of information on the torrent file to be monitored, connection log information, standard time information, tracker information, and connection details information.

In the present invention, the apparatus may further include a DB server and a capture server configured to store information on the peer distributing the torrent file and a captured image of a monitoring screen, and a web server configured to manage the information stored in the DB server and the capture server, wherein, when the managed information is submitted as the evidence of illegal distribution of the copyrighted work, only illegal distribution information of a desired torrent file may be searched through the web server and the searched information may be output as a report.

In the present invention, when the report submitted as the evidence of illegal distribution of the copyrighted work is output, the web server may specify a period from a time point when a peer to be monitored is first discovered as a Leecher with some file pieces or as a Seeder with all file pieces to a time point when the peer is last detected as the Seeder after being switched to the Seeder, as the period of illegal distribution of the copyrighted work through the torrent network, and may allow the specified period to be included in the report when the report is output.

### BRIEF DESCRIPTION OF THE DRAWINGS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment.

In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components.

Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components.

Accordingly, embodiments consisting of a subset of the components described in one embodiment are also included within the scope of the present disclosure. In addition, exemplary embodiments that include other components in addition to the components described in the various embodiments are also included in the scope of the present disclosure.

The above and other objects, features and advantages of the present invention will become more apparent to those of ordinary skill in the art by describing exemplary embodiments thereof in detail with reference to the accompanying drawings, in which:

FIG. 1 is an exemplary diagram illustrating a schematic configuration of an apparatus for monitoring illegal distribution of copyrighted works through a torrent network according to an embodiment of the present invention;

FIG. 2 is an exemplary diagram illustrating a torrent file monitoring screen output through a monitoring screen display in FIG. 1;

FIG. 3 is a flowchart illustrating a method for monitoring illegal distribution of copyrighted works through a torrent network according to an embodiment of the present invention;

FIG. 4 is a flowchart illustrating a method of checking information on a peer distributing a torrent file and a current status of the peer, and then obtaining evidence to specify a period of illegal distribution of the copyrighted work through the torrent network, in FIG. 3;

FIG. 5 is an exemplary diagram illustrating a captured image of a monitoring screen used to calculate the period of illegal distribution of the copyrighted work of the peer distributing a torrent file, in FIG. 4;

FIG. 6 is an exemplary diagram illustrating an operation in which a processor only performs monitoring while a peer distributing a torrent file to be monitored is a Leecher, and performs monitoring screen capturing when the peer is switched from the Leecher to a Seeder, in FIG. 1;

FIG. 7 is an exemplary diagram illustrating an operation in which a processor performs monitoring screen capturing when a peer distributing a torrent file to be monitored is finally detected after the peer is switched from a Leecher to a Seeder, in FIG. 1; and

FIGS. 8 and 9 are exemplary diagrams illustrating a screen in which a report submitted information on a peer (IP) to be monitored, which is managed through a web server, and a captured image of a monitoring screen as evidence to relevant organizations is output.

### DETAILED DESCRIPTION OF EXEMPLARY EMBODIMENTS

Hereinafter, an embodiment of an apparatus and method for monitoring illegal distribution of copyrighted works through a torrent network will be described in detail with reference to the accompanying drawings. In this process, the thickness of lines or sizes of components shown in the drawings may be exaggerated for clarity and convenience of explanation. In addition, the terms described below are terms defined in consideration of functions in the present invention, and may vary depending on the intention or custom of the user or operator. Therefore, definitions of these terms should be made based on the content throughout this specification.

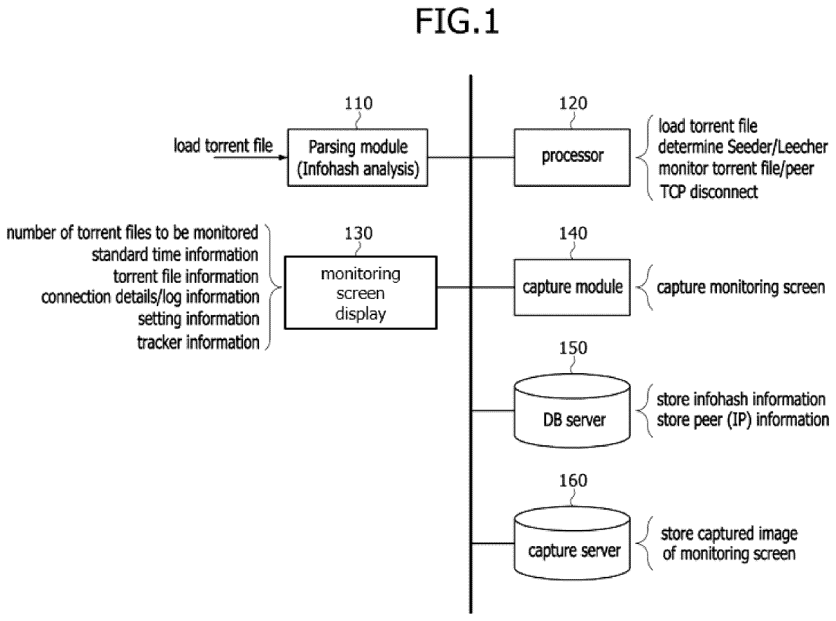

FIG. 1 is an exemplary diagram illustrating the schematic configuration of an apparatus for monitoring illegal distribution of copyrighted works through a torrent network according to an embodiment of the present invention.

As illustrated in FIG. 1, the apparatus for monitoring illegal distribution of copyrighted works through a torrent network according to the present embodiment includes a parsing module 110, a processor 120, a monitoring screen display 130, a capture module 140, a DB server 150, and a capture server 160.

The parsing module 110 loads a torrent file and analyzes infohash information.

The torrent file is a file corresponding to copyrighted works to be monitored, and the processor 120 may sequentially load a plurality of torrent files registered in advance in an index folder (or index server) (not shown) to analyze the infohash information through the parsing module 110.

The processor 120 may check information on a peer distributing the torrent file designated as the copyrighted work to be monitored and a current status (Seeder/Leecher) of the peer.

The processor 120 acquires evidence (e.g., captured image of the monitoring screen) that can prove a period of illegal distribution (i.e., copyright infringement period) of the copyrighted work of the peer distributing the torrent file designated as the copyrighted work to be monitored.

The processor 120 stores information on the peer (TP) to be monitored and the captured image of the monitoring screen in the DB server 150 and the capture server 160, and manages the information stored in the DB server 150 and the capture server 160 through a web server (not shown).

The monitoring screen display 130 outputs, as a display screen, a monitoring screen including information on the number of torrent files to be monitored, torrent file information, connection log information, settings information, standard time information (e.g., time provided by Korea Research Institute of Standards and Science), tracker information, and connection details information.

The capture module 140 captures the monitoring screen when an event with a designated condition (e.g., an event designated to capture First Seen, Seed Time, and Last Seen) occurs.

The DB server 150 stores information on the peer (TP) to be monitored and information on the torrent file being distributed by the peer.

The capture server 160 stores the evidence (e.g., captured image of the monitoring screen) that can prove the period of illegal distribution (i.e., copyright infringement period) of the copyrighted work of the peer distributing the torrent file designated as the copyrighted work to be monitored.

At this time, the processor 120 may integrate and execute the functions of the parsing module 110, the monitoring screen display 130, and the capture module 140. However, in the present embodiment, to facilitate understanding, the functions of the respective modules 110, 130, and 140 are described separately.

In addition, the DB server 150 and the capture server 160 do not necessarily have to be configured separately and may be integrated into one server. For example, the DB server 150 may integrate with the capture server 160.

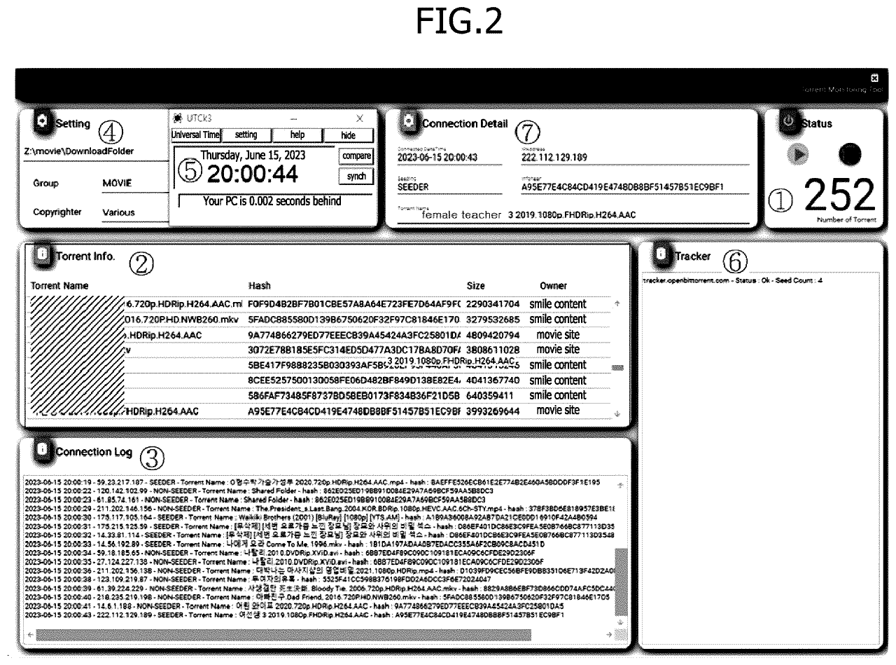

FIG. 2 is an exemplary diagram illustrating a torrent file monitoring screen output through the monitoring screen display in FIG. 1.

Referring to FIG. 2, the torrent file monitoring screen may include an area \textcircled{1} of information on the number of torrent files to be monitored, a torrent file information area \textcircled{2}, a connection log information area \textcircled{3}, a settings information area \textcircled{4}, a standard time information area \textcircled{5} (e.g., time provided by Korea Research Institute of Standards and Science), a tracker information area \textcircled{6}, and a connection details information area \textcircled{7}.

The processor 120 may divide the torrent file monitoring screen into a plurality of screen areas through the monitoring screen display 120 and display each information area \textcircled{1} to \textcircled{7}.

The area \textcircled{1} of information on the number of torrent files to be monitored may display the total number of torrent files currently being monitored.

The torrent file information area \textcircled{2} may display a torrent name, infohash, the number of file pieces, a size of each file piece, an owner of the copyrighted work, and the like.

The connection log information area \textcircled{3} may display a plurality of pieces of information (e.g., time, peer {IP}, peer status {Seeder/non-Seeder}, torrent name {torrent file name}, infohash information) that shows the status of the peer for each torrent file.

The settings information area \textcircled{4} may display the plurality of pieces of torrent file information designated as the copyrighted work to be monitored.

The standard time information area \textcircled{5} may display the time provided by Korea Research Institute of Standards and Science in order to prove that the time is not manipulated when the processor 120 acquires evidence (i.e., captured image of the monitoring screen) capable of proving the period (i.e., copyright infringement period) of illegal distribution of the copyrighted work of the peer distributing the torrent file designated as the copyrighted work to be monitored, and to increase the reliability of the captured image of the monitoring screen.

The tracker information area \textcircled{6} may display information on trackers (i.e., a site with a server that records upload/download figures by inputting a specific address in a seed file, or a server that connects information between torrent users).

When the user selects an item from a list displayed in the connection log information area \textcircled{3} or selects an item from a list displayed in the torrent file information area \textcircled{2}, the connection details information area \textcircled{7} may display detailed information on the selected item.

The processor 120 may automatically monitor a plurality of torrent files to be monitored, which are registered in the index folder (or index server) (not shown), collect a plurality of pieces of information (e.g., time, peer {IP}, status of the peer {Seeder/non-Seeder}, torrent name {torrent file name}, and infohash information) that can reveal the status of the peer for each torrent file, and display the collected information on the monitoring screen.

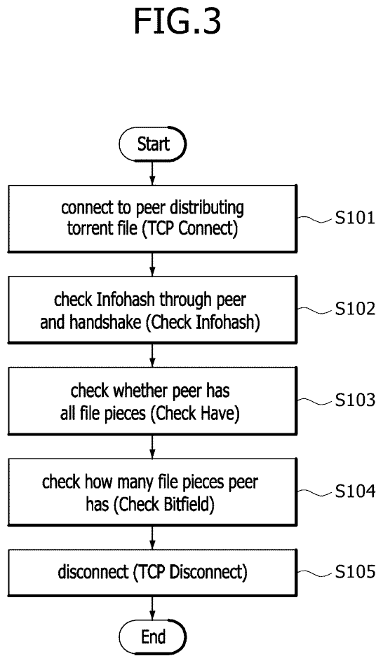

FIG. 3 is a flowchart illustrating a method for monitoring illegal distribution of copyrighted works through a torrent network according to an embodiment of the present invention.

Referring to FIG. 3, the processor 120 connects to a peer that is uploading (distributing) a torrent file in operation S101.

In operation S102, the processor 120 checks (Check Infohash) whether the peer uploading (distributing) the torrent file has the same infohash as infohash of the torrent file of the copyrighted work to be monitored.

Through infohash check, when the torrent file being distributed (uploaded/downloaded) by the peer has the same infohash as infohash of the torrent file of the copyrighted work to be monitored, in operation S103, the processor 120 checks whether the peer has all file pieces.

When the peer distributing the torrent file does not have all the file pieces, the processor 120 checks how many file pieces the peer has in operation S104 (Check Bitfield).

Accordingly, the peer distributing the torrent file returns information indicating that the peer has all the file pieces to the processor 120, or returns information indicating how many file pieces the peer has among all the file pieces to the processor 120.

Accordingly, through file piece information (i.e., Have information and Bitfield information) received from the peer distributing the torrent file, the processor 120 determines whether the peer distributing the torrent file is a Seeder that is distributing the torrent file while having the entire file pieces or a Leecher (non-Seeder) that has only some file pieces, and then terminates a connection with (access to) the peer distributing the torrent file in operation S105 (TCP Disconnect).

Accordingly, the processor 120 checks only information on the peer distributing the torrent file and the current status (Seeder/Leecher) of the peer distributing the torrent file to disconnect, thereby preventing from downloading the torrent file from the peer distributing the torrent file.

In other words, by checking only the information on the peer distributing the torrent file and the current status (Seeder/Leecher) of the peer distributing the torrent file to disconnect, the processor 120 may only check the information and current status (Seeder/Leecher) of the peer distributing the torrent file without having to download an illegal copyrighted work while not affecting the operation of the peer distributing the torrent file operating as the Seeder or the operation of the peer distributing the torrent file operating as the Leecher (non-Seeder), thereby monitoring illegal distribution of the copyrighted work in a state of integrity without illegality.

In this way, when the information and current status (Seeder/Leecher) of the peer distributing the torrent file are checked, the processor 120 transmits the corresponding information (e.g., infohash, peer {IP}, or captured image of monitoring screen) to the DB server 150 and the capture server 160, respectively.

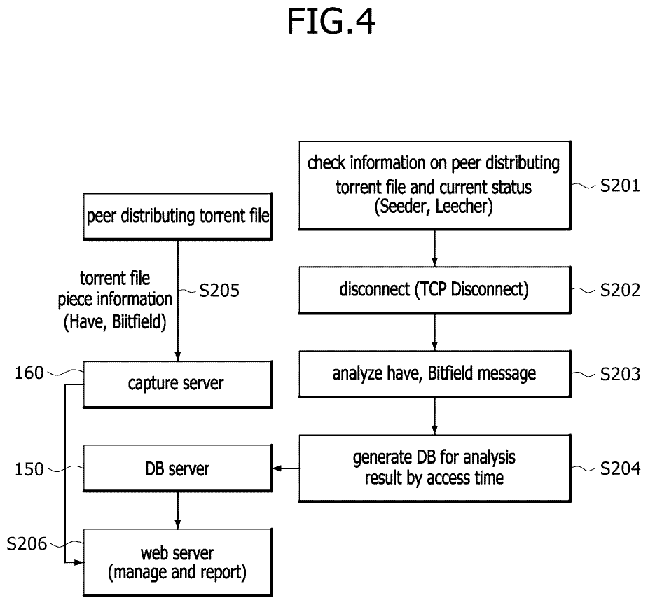

FIG. 4 is a flowchart illustrating a method of checking information on the peer distributing the torrent file and the current status of the peer, and then obtaining evidence to specify a period of illegal distribution of the copyrighted work through a torrent network in FIG. 3.

Referring to FIG. 4, the processor 120 checks the information and current status (Seeder/Leecher) of the peer distributing the torrent file in operation S201, terminates the connection with (access to) the peer distributing the torrent file in operation S202 (TCP disconnect), and analyzes file piece information (i.e., Have information and Bitfield information) returned by the peer distributing the torrent file by the time the peer is connected in operation S203.

That is, the processor 120 repeats a process of connecting to the peer distributing the torrent file at designated time intervals (e.g., 1 minute, 5 minutes, 20 minutes, etc.) and checking and analyzing the information and current status (Seeder/Leecher) of the peer distributing the torrent file.

As this process is repeated, the processor 120 acquires evidence (i.e., captured image of the monitoring screen) that can calculate the period (time) until the peer distributing the torrent file is determined to be the final Seeder while being determined to be the Seeder continuously at designated time intervals after the peer is first determined to be the Seeder, thereby obtaining evidence that can prove the period of illegal distribution of the copyrighted work of the peer distributing the torrent file (i.e., the period of copyright infringement).

At this time, the processor 120 stores the results of analyzing the file piece information (i.e., Have information and Bitfield information) returned by the peer distributing the torrent file by access time in the DB server 150 in operation S204, and captures the file piece information (i.e., Have information and Bitfield information) returned by the peer distributing the torrent file to store the captured information in the capture server 160 in operation S205.

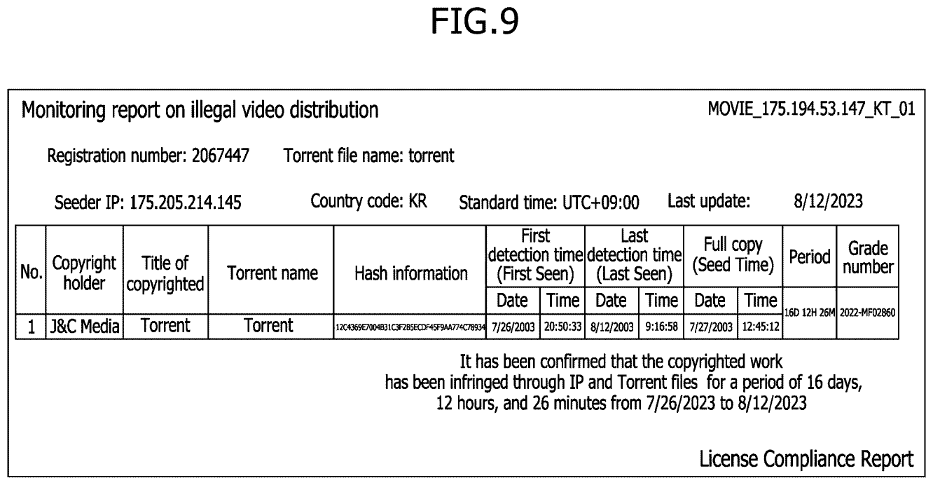

In this way, the information stored in the DB server 150 and the capture server 160 is managed through a web server (not shown), and when necessary (i.e., when submitting evidence), only desired information may be searched and output in the form of a report. (See FIGS. 8 and 9).

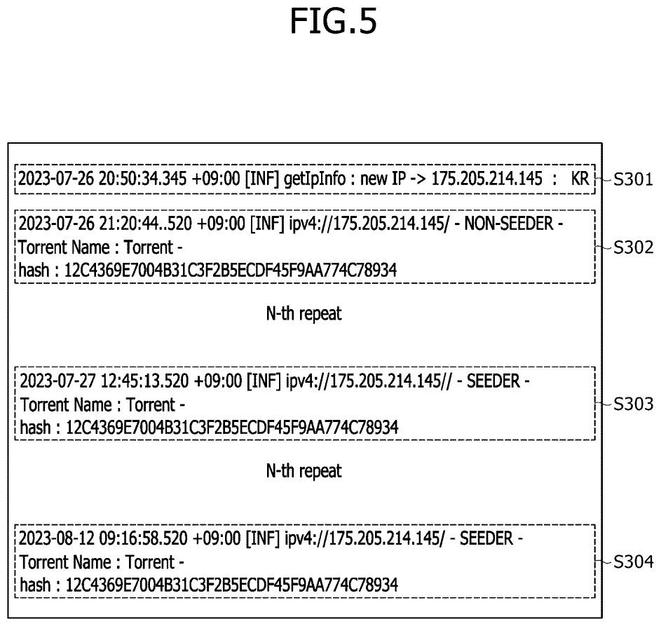

FIG. 5 is an exemplary diagram illustrating a captured image of a monitoring screen used to calculate the period of illegal distribution of the copyrighted work of the peer distributing the torrent file, in FIG. 4.

Referring to FIG. 5, in operation S301, the processor 120 captures a monitoring screen in which time information when a peer distributing a torrent file with the same infohash as infohash of the torrent file of the copyrighted work to be monitored was first discovered is displayed, as “First Seen.”

In operation S302, the processor 120 determines the current status of the peer distributing the torrent file having the same infohash as infohash of the torrent file of the copyrighted work to be monitored, and repeatedly analyzes the current status of the peer n times until the current status of the peer is determined to be the Seeder when the current status of the peer is the Leecher (Non-Seeder).

In operation 303, the processor 120 determines the current status of the peer distributing the torrent file with the same infohash as infohash of the torrent file of the copyrighted work to be monitored, and captures, when the current status of the peer is determined to be the Seeder, a monitoring screen in which the current status of the peer is displayed as the Seeder, as “Seed Time.” Next, the processor 120 repeatedly analyzes the current status of the peer n times until the corresponding peer is no longer discovered.

When a peer distributing a torrent file with the same infohash as infohash of the torrent file of the copyrighted work to be monitored is no longer discovered, in operation S304, the processor 120 captures the monitoring screen in which the status of the peer is finally displayed as the Seeder, as “Last Seen.”

In this way, the processor 120 stores a captured image (First Seen) of the monitoring screen when the peer distributing the torrent file with the same infohash as infohash of the torrent file of the copyrighted work to be monitored is first discovered, a captured image (Seed Time) of the monitoring screen when the peer was first determined to be a Seeder, and a captured image (Last Seen) of the monitoring screen when the peer was last determined to be the Seeder, in the capture server 160.

As a result, it is possible to acquire evidence (i.e., captured image of the monitoring screen) that can prove the period of illegal distribution of the copyrighted work of the peer distributing the torrent file (i.e., the period of copyright infringement).

In order to acquire the evidence (i.e., captured image of the monitoring screen) that can prove the period of illegal distribution of the copyrighted work of the peer distributing the torrent file (i.e., the period of copyright infringement), when an event with designated conditions (i.e., an event designated to capture First Seen, Seed Time, and Last Seen) occurs, the processor 120 pauses a thread (one unit of work that a CPU independently processes; in the case of 4 cores and 4 threads, 4 tasks can be processed simultaneously on 4 cores), fixes the monitoring screen, and then captures the screen.

Here, pausing the thread means intentionally generating a [Not responding] state and fixing the screen. This is similar to, for example, a situation where a [Not responding] message appears in the upper left corner during normal computer work and the program is paused.

However, when the processing speed of the processor 120 is faster than the scrolling speed of information on the monitoring screen, the monitoring screen can be captured in real-time without necessarily pausing the thread.

In addition, the event with designated conditions for capturing the monitoring screen includes the time point when the peer (IP) distributing the same torrent file as the infohash to be monitored is first detected (at the time of First Seen screen capture), the time point when the peer (IP) distributing the same torrent file as infohash to be monitored is first detected as a Seeder (at the time of Seed Time screen capture), and the time point when a Seeder distributing a specific torrent file was last detected through n-th repeated monitoring (Last Seen screen capture time).

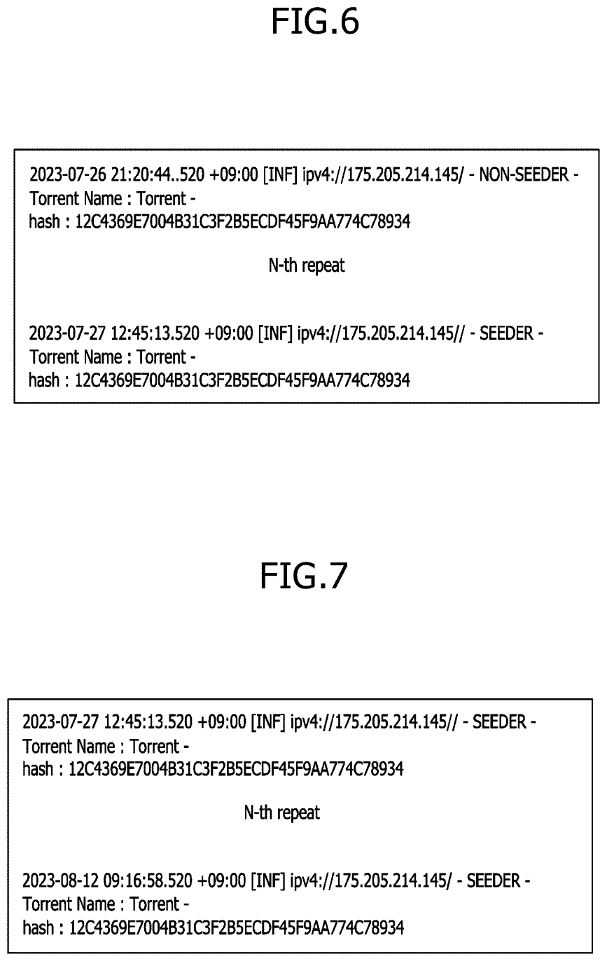

When the peer (IP) distributing the torrent file to be monitored is a Leecher (non-Seeder) that has only some file pieces out of the total file pieces, the processor 120 may set the corresponding peer only as a monitoring target and not as a monitoring screen capture target, and proceed with monitoring screen capture by changing the peer to be monitored, which was the Leecher, to a monitoring screen capture target at the same time as the corresponding peer becomes the Seeder (see FIG. 6).

FIG. 6 is an exemplary diagram illustrating an operation in which a processor only performs monitoring while the peer distributing a torrent file to be monitored is a Leecher, and performs a monitoring screen capture when the peer is switched from the Leecher to a Seeder, in FIG. 1.

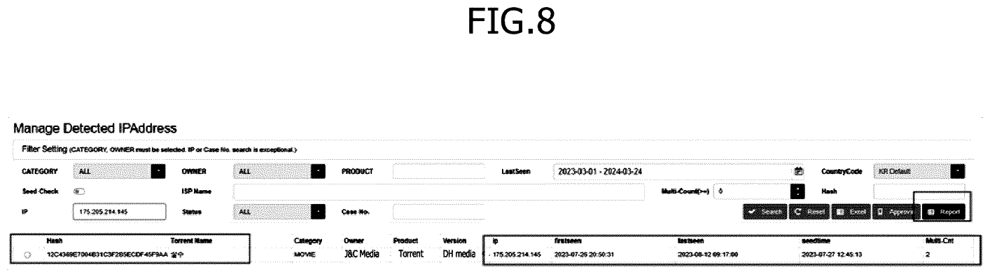

When a peer to be monitored that was the Leecher becomes the Seeder, the processor 120 repeatedly monitors the peer at designated time intervals (e.g., 1 minute, 5 minutes, 20 minutes, etc.), and when communication with the corresponding peer is no longer in progress (i.e., that peer is no longer detected), the processor 120 captures the monitoring screen when the peer was last detected (see FIG. 7).

FIG. 7 is an exemplary diagram illustrating an operation in which a processor performs a monitoring screen capture when a peer distributing a torrent file to be monitored is finally detected after the peer is switched from a Leecher to a Seeder, in FIG. 1.

In this way, the processor 120 stores the information and captured image of the monitoring screen of the peer (IP) to be monitored in the DB server 150 and the capture server 160, and manages the information stored in the DB server 150 and the capture server 160 through a web server (not shown).

FIGS. 8 and 9 are exemplary diagrams illustrating a screen in which a report submitted information on a peer (IP) to be monitored, which is managed through a web server, and a captured image of a screen screening as evidence to relevant organizations is output.

When a report is output, a web server (or processor 120) may calculate a period from a time point (First Seen) when the monitoring screen was first captured at the same time that the peer to be monitored, which was a Leecher, became a Seeder to a time point (Last Seen) when the monitoring screen is captured when the Seeder is last discovered, and allow the calculated periods to be included in the report.

Accordingly, the period from the time point (First Seen) when the monitoring screen was first captured to the time point (Last Seen) when the monitoring screen is last captured, which is included in the report, may be specified as a period of illegal distribution of the copyrighted work through the torrent network (i.e., the period of copyright infringement resulting from the illegal distribution of the copyrighted work).

At this time, the form of the report can be changed in various ways, but as shown in FIG. 9, the corresponding period may include a copyright holder, a copyrighted work name, a torrent name, hash information, a first detection time point (First Seen), a last detection time point (Last Seen), a full copy time point (Seed Time), a Seeder IP, and illegal distribution period information.

As described above, according to the present invention, it is possible to monitor illegal distribution of copyrighted works while not being directly involved in uploading and downloading on the torrent network (in a state of integrity without illegality), and acquire evidence to specify the period of illegal distribution of copyrighted works through the torrent network.

The present invention has been described with reference to the embodiments shown in the drawings, but these are merely exemplary, and those of ordinary skill in the art will appreciate that various modifications and equivalent other embodiments are possible therefrom. Therefore, the true technical scope of the present invention should be determined by the technical idea of the appended claims.

The embodiments and embodiments described herein can be implemented, for example, in a method or process, device, software program, data stream, or signal. Although considered only in the context of a single implementation (e.g., considered only as a method), the implementations of the features considered may also be implemented in other forms (e.g., devices or programs). The device can be implemented, for example, with the appropriate hardware, software, and firmware. These methods can be implemented, for example, within a processor, which refers to processing devices in general, including, for example, computers, microprocessors, integrated circuits, or programmable logic devices. Processors also include communication devices such as computers, mobile phones, portable/personal digital assistants (“PDAs”), and other devices that facilitate the communication of information between end users.

What is claimed is:

1. A method for monitoring illegal distribution of copyrighted works through a torrent network, the method comprising:
checking, by a processor, information on a peer distributing a torrent file designated as copyrighted works to be monitored and whether a current status of the peer is a Seeder or a Leecher; and
when the peer is checked to be the Seeder, obtaining, by the processor, a captured image of a monitoring screen of the peer distributing the torrent file as evidence to prove a period of illegal distribution of the copyrighted work.

2. The method of claim 1, wherein, after the obtaining of the captured image of the monitoring screen of the peer distributing the torrent file, the processor stores the information on the peer distributing the torrent file and the captured image of the monitoring screen in a DB server and a capture server, and manages the information stored in the DB server and the capture server through a web server, whereby, when the managed information is submitted as the evidence of illegal distribution of the copyrighted work, the processor is implemented to search for only illegal distribution information of a desired torrent file through the web server and output the searched information as a report.

3. The method of claim 2, wherein, when the report submitted as the evidence of illegal distribution of the copyrighted work is output, the web server specifies a period from a time point when a peer to be monitored is first discovered as a Leecher with some file pieces or as a Seeder with all file pieces to a time point when the peer is last detected as the Seeder after being switched to the Seeder, as the period of illegal distribution of the copyrighted work through the torrent network, and allows the specified period to be included in the report when the report is output.

4. The method of claim 1, wherein, in order to check the peer distributing the torrent file designated as the copyrighted work to be monitored, the processor loads the torrent file to analyze infohash information, and checks whether the corresponding torrent file has the same infohash as infohash of the torrent file of the copyrighted work to be monitored.

5. The method of claim 1, wherein the monitoring screen includes a plurality of areas displaying at least one of information on the number of torrent files to be monitored, torrent file information, connection log information, settings information, standard time information, tracker information, and connection details information.

6. The method of claim 1, after the checking whether the current status of the peer is the Seeder or the Leecher, further comprising:
terminating, by the processor, a connection with the peer distributing the torrent file to prevent from downloading the torrent file,
wherein, in order to monitor the peer distributing the torrent file, the checking whether the current status of the peer is the Seeder or the Leecher and the terminating of the connection with the peer distributing the torrent file are repeatedly performed at a designated time interval.

7. The method of claim 1, wherein, in order to acquire the evidence that can prove the period of illegal distribution of the copyrighted work, the processor is configured to:
repeatedly monitor the peer distributing the torrent file with the same infohash as infohash of the torrent file of the copyrighted work to be monitored at a designated time interval;
capture the monitoring screen (First Seen) when the peer is first discovered;
capture the monitoring screen (Seed Time) when the peer is determined to be the Seeder; and
capture the monitoring screen (Last Seen) when the peer is finally discovered.

8. An apparatus for monitoring illegal distribution of copyrighted works through a torrent network, the apparatus comprising:
a processor configured to check information on a peer distributing a torrent file designated as copyrighted works to be monitored and whether a current status of the peer is a Seeder or a Leecher, and acquire, when peer is checked to be the Seeder, a captured image of a monitoring screen of the peer distributing the torrent file as evidence to prove a period of illegal distribution of the copyrighted work; and
a monitoring screen display configured to display at least one of information on the torrent file to be monitored, connection log information, standard time information, tracker information, and connection details information.

9. The apparatus of claim 8, further comprising:
a DB server and a capture server configured to store information on the peer distributing the torrent file and a captured image of a monitoring screen; and
a web server configured to manage the information stored in the DB server and the capture server,
wherein, when the managed information is submitted as the evidence of illegal distribution of the copyrighted work, only illegal distribution information of a desired torrent file is searched through the web server and the searched information is output as a report.

10. The apparatus of claim 9, wherein, when the report submitted as the evidence of illegal distribution of the copyrighted work is output, the web server specifies a period from a time point when a peer to be monitored is first discovered as a Leecher with some file pieces or as a Seeder with all file pieces to a time point when the peer is last detected as the Seeder after being switched to the Seeder, as the period of illegal distribution of the copyrighted work through the torrent network, and allows the specified period to be included in the report when the report is output.
